(19) United States
(12) Patent Application Publication
(10) Pub. No.: US 2006/0210271 A1
(43) Pub. Date: Sep. 21, 2006

(54) Station-side apparatus in optical communication

(75) Inventor: Kazuyuki Mori, Kawasaki (JP)

Correspondence Address: BINGHAM MCCUTCHEN LLP, 3000 K STREET, NW, BOX IP, WASHINGTON, DC, 20007, US

(73) Assignee: FUJITSU LIMITED

(21) Appl. No.: 11/169,697

(22) Filed: Jun. 30, 2005

(30) Foreign Application Priority Data
Mar. 16, 2005 (JP) 2005-076075

(51) Int. Cl. H04J 14/00

(52) U.S. Cl. 398/71

(57) ABSTRACT

A multiplexing/demultiplexing unit demultiplexes an input light according to a wavelength, and multiplexes a plurality of wavelength components from a plurality of semiconductor optical amplifiers into a multiplexed light. A control unit performs a gain control for each of the semiconductor optical amplifiers. A receiving unit receives an optical signal after performing the gain control for each of a plurality of semiconductor optical amplifiers belonging to each subscriber-side apparatus, based on each of the wavelength components included in the multiplexed light.

### CROSS-REFERENCE TO RELATED APPLICATIONS

This application is based upon and claims the benefit of priority from the prior Japanese Patent Application No.2005-076075, filed on Mar. 16, 2005, the entire contents of which are incorporated herein by reference.

### BACKGROUND OF THE INVENTION

1. Field of the Invention

The present invention relates to an optical transmitting apparatus for transmitting optical signals in an optical fiber network, and more particularly to an optical transmitting apparatus that is used at a station side, and that transmits optical signals using wavelength division multiplexing (WDM) light.

2. Description of the Related Art

Conventionally, a passive optical network (PON) is applied to an optical communication in an optical fiber network. In the PON, a branching device is arranged at some point of an optical fiber so that the optical fiber is led-in to a communication terminal in each of subscriber homes. For example, in a gigabit ether (GE)-PON, optical signals with 1 gigabit (Gbit) transmitted through an optical fiber are time-divided to be allocated to subscribers. In recent years, to expand capacity of a single optical fiber in transmitting signals, a WDM-PON technology is applied. In the WDM-PON, optical signals having various wavelengths are multiplexed to be transmitted through a single optical fiber. Optical signals having one wavelength are allocated to a subscriber (see, for example, Japanese Patent Application Laid-Open No. 2004-241855 and Japanese Patent Application Laid-Open No. H10-229385).

However, the technology disclosed in Japanese Patent Application Laid-Open No. 2004-241855 requires performing a wavelength control on optical signals at a transmitting/receiving apparatus at both a station side and a subscriber side. For the wavelength control, a distributed feed-back laser-diode (DFB-LD) including a Peltier element, with which wavelength can be controlled corresponding to temperature, is necessary in each transmitting/receiving apparatus. Such apparatus is expensive, therefore, an optical transmission system, which includes such expensive apparatus at both the station side and the subscriber side, become further expensive.

On the other hand, in the technology disclosed in Japanese Patent Application Laid-Open No. H10-229385, a semiconductor optical amplifier with a coating having high reflectivity, such as a semiconductor optical amplifier (SOA), is arranged at one end of the transmitting/receiving apparatus at the subscriber side so that turning-back is caused using gain modulation. Such a structure enables the wavelength control without using the DFB-LD having a Peltier element. Therefore, a cost for the transmitting/receiving apparatus at the subscriber side is reduced. However, for the transmitting/receiving apparatus at the station side, it is necessary to prepare the DFB-LD having a wavelength control function that can control all wavelengths to be allocated to each of the transmitting/receiving apparatuses of subscribers to perform the wavelength control at the station side. Therefore, the transmitting/receiving apparatus at the station side becomes more expensive and cost is increased totally.

### SUMMARY OF THE INVENTION

It is an object of the present invention to at least solve the problems in the conventional technology.

A station-side apparatus according to one aspect of the present invention, which is connected to a plurality of subscriber-side apparatuses via an optical transmission path, includes a plurality of semiconductor optical amplifiers of reflection type to each of which an input light of a different wavelength is input; a multiplexing/demultiplexing unit that demultiplexes the input light according to a wavelength to output to each of the semiconductor optical amplifiers, and multiplexes a plurality of wavelength components from the semiconductor optical amplifiers into a multiplexed light to output to the optical transmission path; a control unit that performs a gain control for each of the semiconductor optical amplifiers; and a receiving unit that receives, from the subscriber-side apparatuses, an optical signal after performing the gain control for each of a plurality of semiconductor optical amplifiers of reflection type belonging to each of the subscriber-side apparatuses, based on each of the wavelength components included in the multiplexed light.

A station-side apparatus according to another aspect of the present invention, which is connected to a plurality of subscriber-side apparatuses via an optical transmission path, includes a plurality of semiconductor optical amplifiers of reflection type to each of which an input light of a different wavelength is input; a multiplexing/demultiplexing unit that demultiplexes the input light according to a wavelength to output to each of the semiconductor optical amplifiers, and multiplexes a plurality of wavelength components from the semiconductor optical amplifiers into a first multiplexed light to output to the optical transmission path; a control unit that performs a gain control for each of the semiconductor optical amplifiers; an output unit that outputs, to the optical transmission path, a second multiplexed light having a plurality of wavelength components that are different from any one of the wavelength components included in the first multiplexed light; and a receiving unit that receives, from the subscriber-side apparatuses, an optical signal after performing the gain control using the second multiplexed light acquired from the output unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic of an optical transmission system according to a first embodiment of the present invention;

FIG. 2 is a schematic for illustrating a format of an optical signal in the optical transmission system;

FIG. 3 is a timing chart of a signal switching between upstream signals and downstream signals in a time sequence;

FIG. 4 is a timing chart of a signal switching between the upstream signals and the downstream signals based on a packet length;

FIG. 5 is a timing chart of a signal switching between the upstream signals and the downstream signals based on a specific pattern;

FIG. 6 is a schematic of an optical transmission system in which two wavelengths are allocated to each subscriber according to a second embodiment of the present invention;

FIG. 7 is a schematic for illustrating a flow of a signal when a coding processing is performed;

FIG. 8 is a timing chart of conversion of a signal transmitted from the station side to the subscriber side;

FIG. 9 is a timing chart of conversion of a signal transmitted from the station side the to subscriber side; and

FIG. 10 is a table of comparison between the present invention and a conventional technology.

### DETAILED DESCRIPTION OF THE PREFERRED EMBODIMENTS

Exemplary embodiments of the present invention will be explained below in detail with reference to the accompanying drawings.

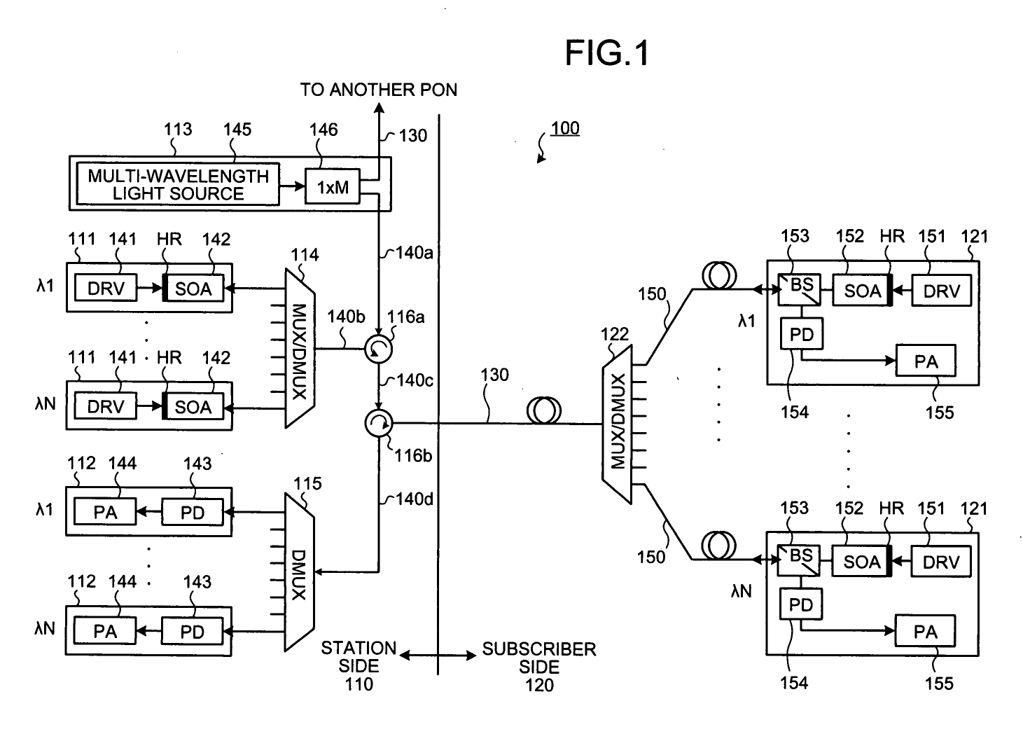

FIG. 1 is a schematic of an optical transmission system according to a first embodiment of the present invention. An optical transmission system 100 includes transmitters 111, receivers 112, a light source unit 113, a light multiplexing/demultiplexing device (MUX/DMUX) 114, a demultiplexer (DMUX) 115, two optical circulators 116a and 116b that are provided at a station side 110, and transmitting/receiving units 121 and a multiplexing/demultiplexing device (MUX/DMUX) 122 that are provided at a subscriber side 120. The station side 110 and the subscriber side 120 are connected through an optical transmission path (an optical fiber) 130. The number of the transmitters 111, the receivers 112, and the transmitting/receiving units 121 correspond to the number of wavelengths included in optical signals multiplexed.

Each of the transmitters 111 includes a control unit (driver) 141 and a reflective-type optical amplifier (SOA) 142 having a coating HR with high reflectivity on a reflecting face thereof. The transmitter 111 is connected to the MUX/DMUX 114. The MUX/DMUX 114 is connected to the optical circulator 116a via an optical fiber 140b. Each of the receivers 112 includes a preamplifier (PA) 144 and a light receiving unit (a photodiode) 143, and it is connected to the DMUX 115.

The DMUX 115 is connected to the optical circulator 116b via an optical fiber 140d. The light source unit 113 includes a multi-wavelength light source 145 and an optical coupler (1×M) 146. One branched light among M branched lights, where M is a positive integer, is connected to the optical circulator 116a via an optical fiber 140a, while the rest of the branched lights (M−1) among the M branched lights are connected to other PONs. The optical circulators 116a and 116b are connected to each other via an optical fiber 140c.

Each transmitting/receiving unit 121 includes a driver (DVR) 151, an SOA 152 having the coating HR with high reflectivity on a reflecting face, a beam splitter (BS) 153, a photodiode (PD) 154, and a preamplifier (PA) 155. The transmitting/receiving unit 121 is connected to the MUX/DMUX 122 via an optical fiber 150. The MUX/DMUX 122 is connected to the optical circulator 116b on the station side 110 via the optical fiber 130. Wavelength multiplexing/demultiplexing elements, such as array waveguide gratings (AWG) are used in the MUX/DMUX 114 and 122, and the DMUX 115.

In the optical transmission system explained above, the transmitter 111 and the receiver 112 on the station side, and the transmitting/receiving unit 121 on the subscriber side 120 perform bi-directional transmission of optical signals. A light source for the optical signal is a multi-wavelength light that is output from the light source unit 113 on the station side 110. Using the multi-wavelength light, each transmitter 111 performs transmission of an optical signal to the subscriber side 120. When an optical signal is transmitted from each of the transmitting/receiving units 121 to the station side 110, the transmitting/receiving unit 121 uses the optical signal transmitted from the transmitter 111 as a light source.

To transmit an optical signal from the station side 110 to the subscriber side 120, a non-modulated light (wavelength multiplexed light), which is a continuous wave (CW) light, including N wavelengths (λ1 to λN) output from the light source unit 113 is taken into the SOA 142 in the transmitter 111. The CW light has a non-modulated continuous waveform and is emitted from a DFB-LD having a wavelength control function or from an optical-frequency comb generator in the multi-wavelength light source 145. The CW light emitted from the multi-wavelength light source 145 is input into the optical coupler (1×M) 146 and is divided equally into M to be output as demultiplexed signals. One of the demultiplexed signals is input into the optical circulator 116a via the optical fiber 140a. At that time, the rest (M−1) of the demultiplexed signals are input to the optical fiber 130 to be a light source for other PONs. The wavelength-multiplexed light output from the light source unit 113 is also input into a unit corresponding to the optical circulator 116a in another station side system that includes constituent elements in the station side 110 except for the light source unit 113. The optical circulator 116a to which the CW light is input outputs the CW light through an output port positioned in a direction of rotation in a counterclockwise direction in FIG. 1 to the optical fiber 140b. The CW light is input from the optical fiber 140b to the MUX/DMUX 114. The MUX/DMUX 114 to which the CW light is input demultiplexes the CW light by wavelength λ1 to λN to output to transmitters corresponding to each wavelength. For example, the CW light having wavelength λ1 is output to the transmitter 111 for wavelength λ1, and the CW light having wavelength λN is output to the transmitter 111 for the wavelength λN. The CW light input to each of the transmitters 111 is output to the SOA 142. In the SOA 142, the CW light is gain-modulated by a transmission signal (an electric signal) input from the DRV 141.

Thus, the CW light is converted into an optical signal that indicates a gain corresponding to the signal and the optical signal is reflected by the coating HR. Thus, the optical signal is turned back from the SOA 142 to be output to the MUX/DMUX 114. The DRV 141 is connected with a coder (a coder A) not shown, and the coder codes a transmission signal to input to the DRV 141 as a binary signal. The CW light is gain-modulated in a first period, and is gain-controlled, while maintaining the CW light in a second period. In other words, the DRV 141 performs gain-modulation based upon information to be transmitted to the subscriber-side apparatus in the first period, and controls the SOA 142 so as to output the CW light to be used during transmission from the transmitting/receiving unit 121 on the subscriber side 120 in the second period.

An optical signal is multiplexed by the MUX/DMUX 114 and output to the optical circulator 116a though the optical fiber 140b. The optical circulator 116a rotates in a counterclockwise direction in FIG. 1 to output the optical signal to the optical circulator 116b though the optical fiber 140c. Since the optical circulator 116b outputs the optical signal to the port positioned in the direction of rotation in a counterclockwise direction in FIG. 1, the optical circulator 116b outputs the optical signal to the MUX/DMUX 122 on the subscriber side 120 through the optical fiber 130.

The MUX/DMUX 122 to which the optical signal is input demultiplexes the optical signal by wavelength to output the optical signal to corresponding unit of the transmitting/receiving units 121 via the optical fiber 150. The optical signal input into each of the transmitting/receiving units 121 is split to two split optical signals by the beam splitter (BS) 153. One of the split optical signals is output to the PD 154, while the other is output to the SOA 152 to be used as a light source for a transmission signal.

After the optical signal input to the PD 154 is converted into an electric signal. The electric signal is amplified by the PA 155. Thus, the transmission signal is received by an apparatus on the subscriber side 120, and a reception action is performed by the apparatus.

To transmit an optical signal from the subscriber side 120 to the station side 110, a transmission signal, which is an electric signal, is first input from the driver (DRV) 151 to the SOA 152. One of two optical signals obtained by splitting the optical signal in the beam splitter (BS) 153 is input into the SOA 152. The optical signal input into the SOA 152 is gain-modulated by the transmission signal input from the DRV 151 and the optical signal is reflected by the coating HR, so that the optical signal is output to the MUX/DMUX 122 via the optical fiber 150. The gain modulation is performed using a CW light in the second period formed by the DRV 141 on the station side 110. The optical signal is multiplexed with an optical signal transmitted from another unit of the transmitting/receiving units 121 performing transmission/reception of an optical signal having a different wavelength in the MUX/DMUX 122 and the optical signal multiplexed is transmitted to the station side 110 via the optical fiber 130.

The optical signal transmitted from the subscriber side 120 is first input into the optical circulator 116b. The optical circulator 116b rotates to output the optical signal to the optical fiber 140d. Therefore, the optical signal transmitted from the subscriber 120 is input to the DMUX 115. The optical signal input to the DMUX 115 is demultiplexed by wavelength. Each optical signal obtained by demultiplexing is output to the receivers 112 corresponding to each wavelength. After each optical signal input into the photodiode (PD) 143 is converted into an electric signal, the optical signal is amplified by the preamplifier (PA) 144.

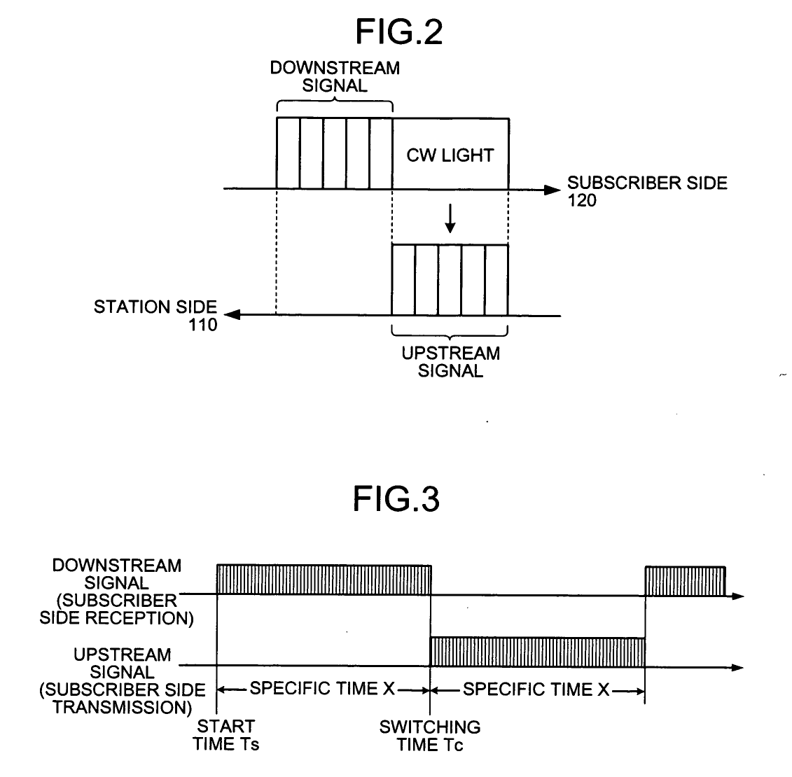

FIG. 2 is a schematic for illustrating a format of an optical signal in the optical transmission system. An optical signal transmitted through the optical fiber 130 that connects the station side 110 and the subscriber side 120 is shown in FIG. 2 for respective transmission directions. In FIG. 2, a reception signal for the subscriber side 120 is represented as a downstream signal, while a transmission signal for the subscriber side 120 is represented as an upstream signal. Transmission of an optical signal performed using such a format is generally called “a ping-pong transmission”.

As described in the explanation about the transmission and reception actions with reference to FIG. 1, the optical fiber 130 connecting the station side 110 and the subscriber side 120 always allows bi-directional transmissions of a signal between the station side 110 and the subscriber side 120. Since transmission from the subscriber side 120 is performed using a signal from the station side 110, when a bit sequence modulated on the station side 110 is superimposed with a signal on the subscriber side 120, accurate transmission is made impossible unless a special coding processing is performed. As shown in FIG. 2, therefore, transmissions of a downstream signal and an upstream signal are performed at different timings in a time-divisional manner. In other words, after a downstream signal is transmitted for a predetermined period (a first period), while the CW light which has not been converted into an optical signal is being transmitted (a second period), the CW light is gain-modulated to an optical signal, and the optical signal is transmitted as an upstream signal.

Timing charts shown in FIGS. 3 to 5 respectively represent transmission timing of the downstream signal on an upper stage and transmission timing of the upstream signal on a lower stage. FIG. 3 is a timing chart of a signal switching between upstream signals and downstream signals in a time sequence. In this switching method, timekeeping conducted by a timer is started from a start time Ts that is a leading head of a downstream signal. When a specific time X has elapsed from the start time Ts, it is a switching time Tc. When the switching time Tc has come, the transmission of the downstream signal is stopped, and transmission of the upstream signal is started. Thus, switching between the upstream signal and the upstream signal is performed.

When another specific time X has elapsed from the switching time Tc, the transmission of the upstream signal is stopped, and transmission of the downstream signal is started. By repeating such switching, simultaneous transmission of the downstream signal and the upstream signal can be performed without causing superimposition of the upstream signal on the downstream signal. When this process is conducted, it is necessary to define the specific time X as a format for an optical signal to synchronize the start Tc between the transmitter 111 and the transmitting/receiving unit 121.

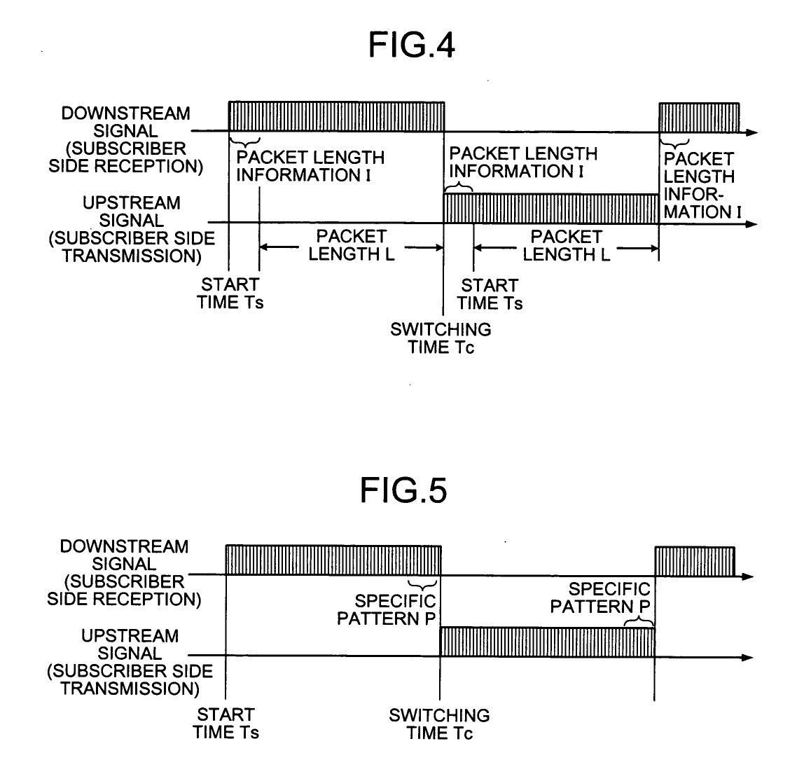

FIG. 4 is a timing chart of a signal switching between the upstream signals and the downstream signals based on a packet length. In this switching method, a region in which a length of a packet called packet length information I is provided in a header portion of an optical signal, so that switching between the upstream signal and the downstream signal is performed counting a packet length L that is described in the packet length information I. First, when transmission of the downstream signal is started from the start time Ts, the transmitting/receiving unit 121reads the packet length L from the packet length information I in the downstream signal received. The transmitting/receiving unit 121 counts the packet length L, and when a value counted reaches the packet length L, it is the switching time Tc, so that transmission of the upstream signal including the packet length information I is started. By repeating such switching, simultaneous transmission of the downstream signal and the upstream signal can be performed without causing superimposition of the upstream signal on the downstream signal.

FIG. 5 is a timing chart of a signal switching between the upstream signals and the downstream signals based on a specific pattern. In this switching method, switching between the downstream signal and the upstream signal is performed by the receiver 112 and the transmitting/receiving unit 121, storing specific patterns recognizable at ends of packets of optical signals. First, transmission of the downstream signal is started from the start time Ts, and when the transmitting/receiving unit 121 recognizes a specific pattern P, transmission of the upstream signal including the specific pattern P is started from the switching time Tc. When the receiver 112 recognizes the specific pattern P, transmission of the downstream signal is again started. By repeating such switching, simultaneous transmission of the downstream signal and the upstream signal can be performed without causing superimposition of the downstream signal on the upstream signal.

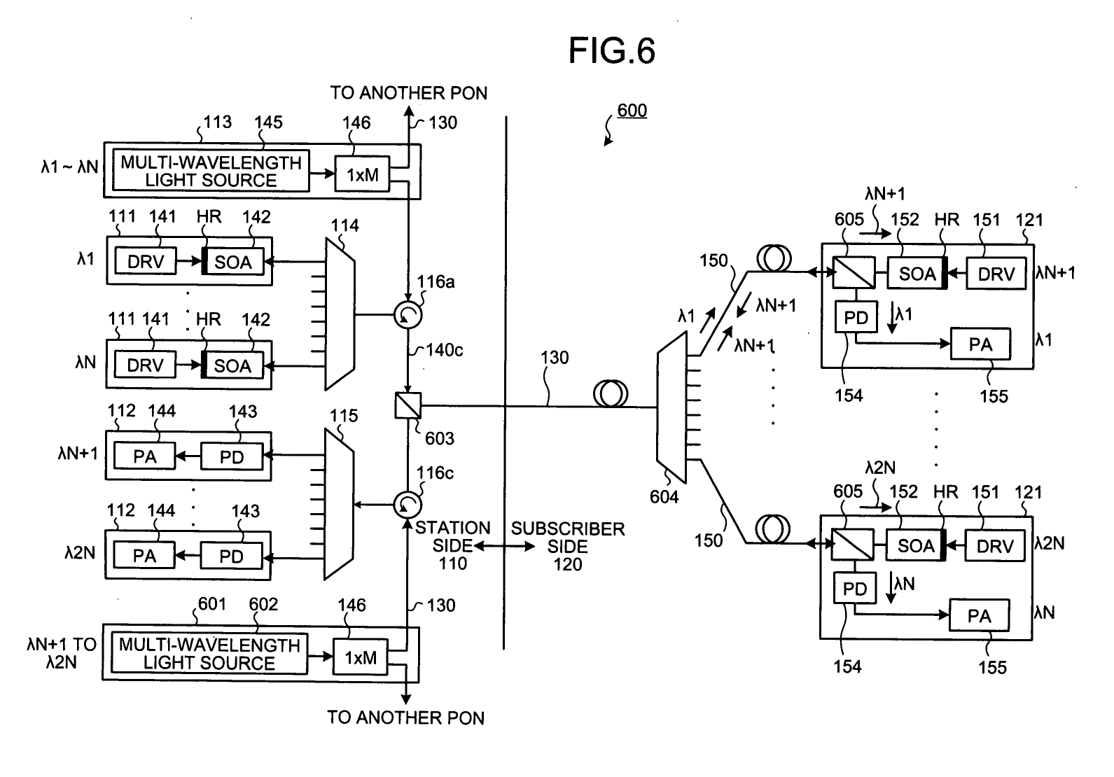

FIG. 6 is a schematic of an optical transmission system in which two wavelengths are allocated to each subscriber according to a second embodiment of the present invention. An optical transmission system shown in FIG. 6 includes a light source unit 601 and an optical circulator 116c that are additional components to the optical transmission system 100 shown in FIG. 1. A wavelength filter (a multiplexing/demultiplexing device) 603 is provided instead of the optical circulator 116b, a circulating wavelength filter 604 is provided instead of the MUX/DMUX 122, and a wavelength filter 605 is provided instead of the beam splitter (BS) 153. Like components to those shown in FIG. 1 are denoted by like reference characters and explanation thereof is omitted.

The optical transmission system 600 allocates optical signals corresponding to two wavelengths to each subscriber so that bi-directional transmission of an optical signal using one of the optical signals exclusively for the upstream signal and the other thereof exclusively for the downstream signal. Accordingly, the light source unit 113 is used as a light source exclusively for an optical signal transmitted from the transmitter 111, which is the downstream signal, as explained with reference to FIG. 1. A multi-wavelength light source 602 in the light source unit 601 is used as a light source exclusively for the upstream signal. Therefore, the multi-wavelength light source 602 is set so as to emit a CW light having a different wavelength from that of the CW light emitted by the multi-wavelength light source 145 in the light source unit 113. Specifically, the multi-wavelength light source 145 emits lights having wavelengths of λ1 to λN while the multi-wavelength light source 602 may emit lights having wavelengths of (λN+1) to λ2N.

A CW light exclusive to the upstream signal emitted from the light source unit 601 is first input to the optical circulator 116c. The optical circulator 116c outputs the CW light through a port positioned in a direction of rotation in a counterclockwise direction in FIG. 6 to the multiplexing/demultiplexing device 603. The CW light is input to the circulating wavelength filter 604 via the optical fiber 130.

The circulating wavelength filter 604 outputs the CW light of each wavelength (λN+1) to λ2N to the transmitting/receiving unit 121 corresponding to each of the wavelengths, in accordance with a certain rule. The wavelength filter 605 separates lights transmitted from the optical fiber 130 into the CW light serving as a light source for the upstream signal and the downstream signal, which is the optical signal transmitted from the transmitter 111. The CW light is output to the SOA 132 and the optical signal is output to the PD 154. Accordingly, the CW light is input to the SOA 152 by the wavelength filter 605. In the SOA 152, the CW light is gain-modulated according to a transmission signal from the driver (DRV) 151. The optical signal is reflected by the coating HR so that the CW light is transmitted to the station side 110 as the upstream signal.

The optical signal output from the transmitting/receiving unit 121 is input to the wavelength filter 605 via the optical fiber 150, and multiplexed with another optical signal having a different wavelength output from another unit of the transmitting/receiving unit 121. An optical signal obtained by multiplexing is input to the multiplexing/demultiplexing device 603 via the optical fiber 130. The multiplexing/demultiplexing device 603 inputs, to the DMUX 115, the optical signal from the subscriber side 120. The optical signal of each wavelength is input to the receivers 112 corresponding to the wavelengths ((λN+1) to λ2N).

Thus, by shifting wavebands of the CW light serving as the light source for the upstream signal and the CW light serving as the light source for the downstream signal from each other, the station side 110 and the subscriber side 120 can perform bi-directional transmission of optical signals without performing the switching between the upstream signal and the downstream signal. While in the example shown in FIG. 6, the light source unit 113 having the light source for the downstream signal having wavelengths λ1 to λN and the light source unit 601 having the light source having wavelengths ((λN+1) to λ2N) are used, a light source unit having a light source having a wide band of λ1 to λ2N may be used.

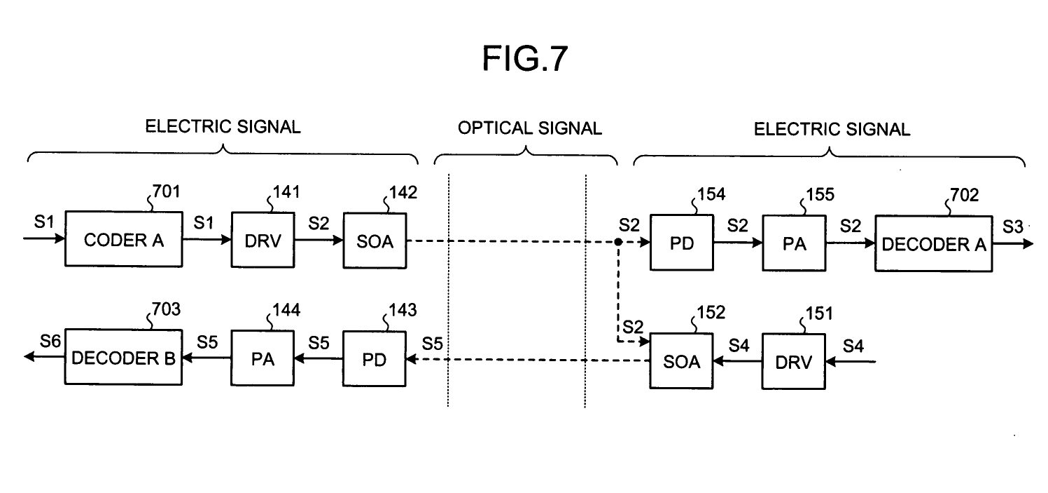

FIG. 7 is a schematic for illustrating a flow of a signal when a coding processing is performed in the example according to the first embodiment (see FIG. 1). FIG. 7 represents a flow of a signal transmitted from the transmitter 111 on the station side 110 to the transmitting/receiving unit 121 on the subscriber side 120 and a flow of a signal transmitted from the transmitting/receiving unit 121 on the subscriber side 120 to the receiver 112 on the station side 110 in the optical transmission system as according to the first embodiment (see FIG. 1). In the first embodiment, an optical signal transmitted from the subscriber side 120 is constituted by reusing lights in optical signals transmitted from the station side 110. Therefore, all the light signals are converted from 1-bit signals into 2-bit signals by 1B to 2B conversion. The optical signals on the transmission side and the reception side are overlaid to be transmitted and received in parallel instead of the ping-pong transmission.

Specifically, a signal represented as “1” for 1 bit is represented as “10” for 2 bits, and a signal represented as “0” for 1 bit is represented as “01” for 2 bit. This is because, even when an optical signal output from the subscriber side 120 is to be output using a signal maintaining a form of 1 bit, a signal “0” cannot be gain-modulated to a signal “1”, while a signal “1” can be gain-modulated to a signal “0”. Accordingly, any signal can be gain-modulated by making a signal representing “0” contain an element of “1”.

FIG. 8 is a timing chart of conversion of a signal transmitted from the station side to the subscriber side. S1 shown in FIG. 7 is an original signal represented by 1 bit and input to a coder A701. In the example shown, the original signal is defined as “101100”. S2 represents a signal obtained by converting the original signal to 2-bit signal by the coder A701. As explained previously, “1” is converted to “10”, and “0” is converted to “01”. Accordingly, the original signal is converted to “100110100101”. The signal S2 is input to the DRV 141 through the coder A701.

The signal S2 is input from the DRV 141 to the SOA 142, and then transmitted from the SOA 142 to the subscriber side 120. The PD 154 inputs the signal S2 transmitted from the station side 110 to the PA 155 as an electric signal. Finally, the signal S2 input from the PA 155 to a decoder A702 is inversely converted from the 2-bit signal to a 1-bit signal. Accordingly, the signal S2 is converted to a 1-bit signal “101100” as shown as a signal S3.

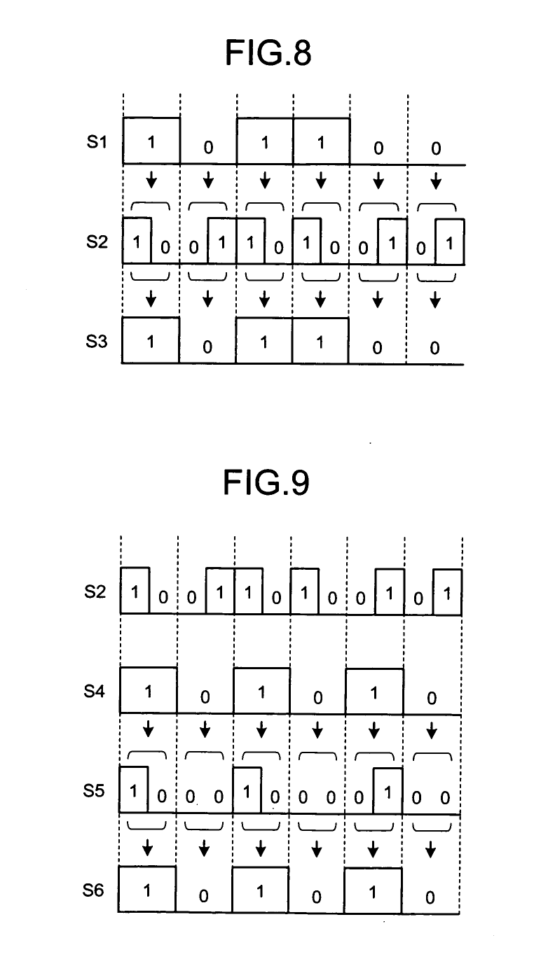

FIG. 9 is a timing chart of conversion of a signal transmitted from the subscriber side 120 to the station side 110. An optical signal is transmitted to the station side, using the signal S2 shown in FIG. 7 from the station side 110 as a light source. “1” is converted to “10” or “01”, and “0” is converted to “00”. Accordingly, only when the signal from the station side 110 is converted to “0”, gain modulation (overlay) is performed. This is because the gain modulation to a signal from the station side 110 is minimized and an optical signal transmitted from the subscriber side 120 to the station side 110 is only received and not reused.

The signal S2 is first input to the SOA 152. A signal S4 of “101010” is input from the subscriber side 120 to the driver (DRV) 151. The signal S4 is gain-modulated to a 2-bit signal based upon the signal S2 in the SOA 152. As described above, “1” is converted to “10” or “01”, and “0” is converted to “00”. Accordingly, the transmission signal S4 is gain-modulated based upon the signal S2, and the signal S4 is transmitted to the station side 110 as “100010000100” shown as a signal S5.

The PD 143 inputs the signal S5 transmitted from the subscriber side 120 to the PA 144 as an electric signal. Finally, the signal S5 input from the PA 144 to a decoder B703 is inversely converted from the 2-bit signal to the 1-bit signal. Accordingly, the signal S5 is converted to a 1-bit signal “101010” shown as a signal S6 to be received.

As the overlay approach as described above, not only the transmission system including the conversion from the 1-bit signal to the 2-bit signal, but also an asymmetric transmission system having a high bit rate for the downstream signal and a low bit rate for the upstream signal may be used.

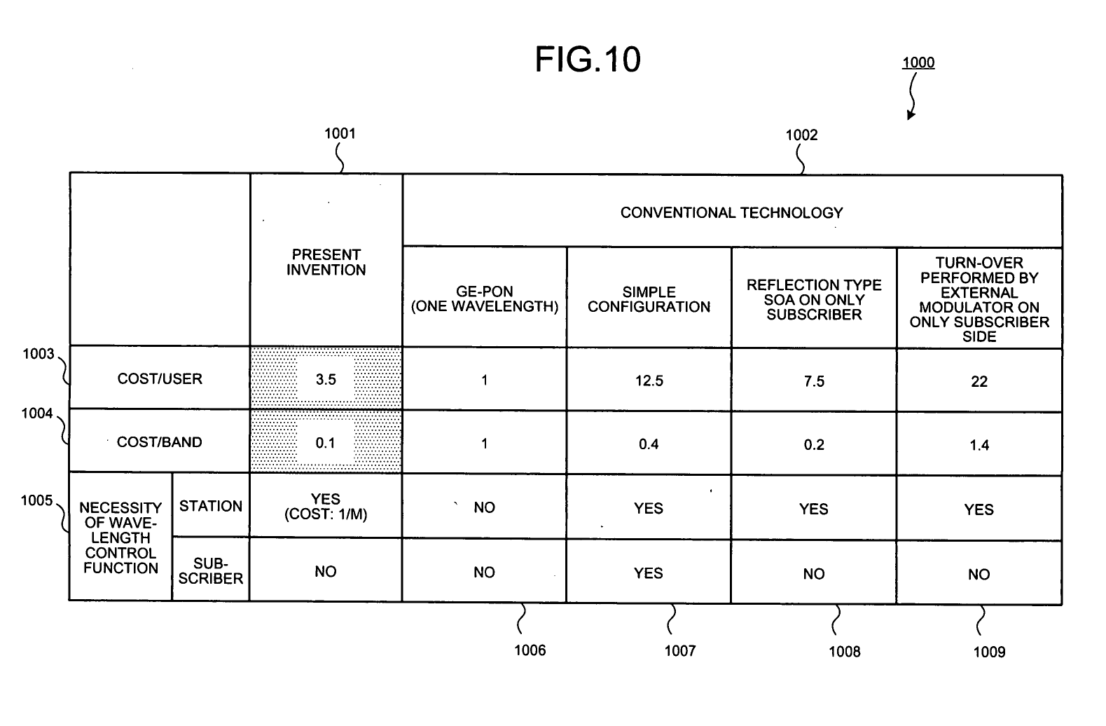

FIG. 10 is a table of comparison between the present invention and a conventional technology. In a table 1000 shown in FIG. 10, estimation on cost when the number of subscribers is 32 and necessity of a wavelength control function in an optical transmission system according to the embodiments of the present invention are shown in comparison with that of the conventional technology. A column 1001 is for the present invention and a column 1002 is for the conventional technology.

In a row 1003, cost per user is shown and in a row 1004, cost per wavelength is shown. All values are based upon values (in column 1006) in the GE-PON transmitting one wavelength over one optical fiber. In a row 1005, whether the wavelength control function is necessary respectively at the station side and the subscriber side is shown.

In columns 1007 to 1009, examples handling a multiplexed signal are shown. The column 1007 corresponds to the technology disclosed in Japanese Patent Application Laid-Open No. 2004-241855, and the column 1008 corresponds to the technology disclosed in Japanese Patent Application Laid-Open No. H10-229385. In the column 1009, an example in which an external modulator is provided instead of the SOA 152 at only the subscriber side 120 so that an optical signal is turned back is shown. As apparent from values in the column 1001, the optical transmission system according to the present invention is most effective in both cost per user and cost per wavelength. Since the wavelength control function may be provided at only the station side 110 in the optical transmission system according to the present invention, and an apparatus having a single wavelength control function is shared by a plurality of PONs, cost can be reduced.

As explained above, according to a station-side apparatus according to the present invention, a light source constituted of an expensive DFB-LD that requires a wavelength control is shared by M systems, a cost burden on each subscriber is reduced to 1/M, where M is a positive integer. Moreover, since the expensive DFB-LD that is conventionally prepared for each subscriber is not required in a station-side apparatus, an optical semiconductor laser amplifier equivalent to an inexpensive a Fabry-Perot laser diode can be used therein. Accordingly, significant cost reduction can be realized in a transmitter at a station side. Furthermore, since an SOA may be one identical to a transmitting/receiving unit on the subscriber side, further cost reduction can be realized.

According to the present invention, transmission of an optical signal can be efficiency achieved.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A station-side apparatus that is connected to a plurality of subscriber-side apparatuses via an optical transmission path, the station-side apparatus comprising:
a plurality of semiconductor optical amplifiers of reflection type to each of which an input light of a different wavelength is input;
a multiplexing/demultiplexing unit that demultiplexes the input light according to a wavelength to output to each of the semiconductor optical amplifiers, and multiplexes a plurality of wavelength components from the semiconductor optical amplifiers into a multiplexed light to output to the optical transmission path;
a control unit that performs a gain control for each of the semiconductor optical amplifiers; and
a receiving unit that receives, from the subscriber-side apparatuses, an optical signal after performing the gain control for each of a plurality of semiconductor optical amplifiers of reflection type belonging to each of the subscriber-side apparatuses, based on each of the wavelength components included in the multiplexed light.

2. The station-side apparatus according to claim 1, further comprising a multi-wavelength-light-source unit that outputs a non-modulated light of a plurality of wavelengths, the multi-wavelength-light-source unit including a splitting unit that splits the non-modulated light into predetermined number of output lights, wherein
a number of the station-side apparatus are arranged corresponding to the predetermined number of output lights.

3. The station-side apparatus according to claim 2, wherein the multi-wavelength-light-source unit includes a multi-wavelength light source that outputs the non-modulated light having a plurality of wavelength bandwidths.

4. The station-side apparatus according to claim 1, further comprising a first optical circulator and a second optical circulator, wherein
the multiplexing/demultiplexing unit acquires the input light by receiving a part of the multiplexed light that is branched into many via the first optical circulator,
the multiplexed light is output to the optical transmission path via the first optical circulator and the second optical circulator, and
the receiving unit receives a multiplexed light from the subscriber-side apparatus via the second optical circulator.

5. The station-side apparatus according to claim 1, wherein the control unit performs the gain control corresponding to information in a first period and performs the gain control for emitting a continuous-wave light in a second period.

6. The station-side apparatus according to claim 1, wherein
the gain control performed in the subscriber-side apparatus is a gain control performed by superimposition of an optical signal after the gain control in the station-side apparatus, and
the receiving unit acquires information from the subscriber-side apparatuses based on the gain control performed by the superimposition.

7. The station-side apparatus according to claim 6, wherein
the control unit converts a code of the optical signal according to a predetermined rule to transmit the optical signal to the subscriber-side apparatus, and
the receiving unit receives a light signal overlaid on an optical signal of which a code is converted in the subscriber-side apparatus, and inversely converts the light signal received according to the predetermined rule.

8. The station-side apparatus according to claim 6, wherein
a bit rate of the optical signal received by the receiving unit is lower than that of the optical signal transmitted by the semiconductor optical amplifiers, making an asymmetric relation.

9. A station-side apparatus that is connected to a plurality of subscriber-side apparatuses via an optical transmission path, the station-side apparatus comprising:
a plurality of semiconductor optical amplifiers of reflection type to each of which an input light of a different wavelength is input;
a multiplexing/demultiplexing unit that demultiplexes the input light according to a wavelength to output to each of the semiconductor optical amplifiers, and multiplexes a plurality of wavelength components from the semiconductor optical amplifiers into a first multiplexed light to output to the optical transmission path;
a control unit that performs a gain control for each of the semiconductor optical amplifiers;
an output unit that outputs, to the optical transmission path, a second multiplexed light having a plurality of wavelength components that are different from any one of the wavelength components included in the first multiplexed light; and
a receiving unit that receives, from the subscriber-side apparatuses, an optical signal after performing the gain control using the second multiplexed light acquired from the output unit.

10. The station-side apparatus according to claim 9, further comprising a multi-wavelength-light-source unit that includes:
a light source that outputs input lights used for the first multiplexed light and the second multiplexed light; and
a wavelength filter that separates the input light output from the light source.
